(19) United States
(12) Patent Application Publication
(10) Pub. No.: US 2026/0342809 A1
(43) Pub. Date: Oct. 29, 2026

(54) ACCELERATED WEB APPLICATION SECURITY WITH FEATURE FINGERPRINTING

(71) Applicant: Palo Alto Networks, Inc., Santa Clara, CA (US)

(72) Inventors: Subramanian Varadarajan, Los Altos, CA (US); Kumaravel Senthivel, San Jose, CA (US)

(21) Appl. No.: 19/188,794

(22) Filed: Apr. 24, 2025

(51) Int. Cl. H04L 9/40

(52) U.S. Cl. CPC H04L 63/1416

(57) ABSTRACT

A web application security service has been created that learns behavior of application traffic for a web application at it changes over time and learns behavior by request type/class. With these learned application traffic behaviors, a margin of acceptable deviation can be defined that closely first to the learned time varying behaviors and used to detect anomalous or suspicious activity in live application traffic. The web application security service can also learn time invariant request patterns for the application traffic and time invariant patterns of requests for each feature of an application (“feature fingerprint”). With the time invariant request pattern, the web application security service can determine anomalous or suspicious activity not detected with the learned volume-based behaviors. With feature fingerprints, the web application security service can identify a suspicious session with a feature request pattern that does not conform to the corresponding feature fingerprint.

### BACKGROUND

The disclosure generally relates to security of applications delivered through a network, such as cloud delivered applications (e.g., CPC subclass H04L 63/00 and CPC subclass G06 21/00).

A web application firewall (WAF) is a firewall that operates at the application layer (Layer 7) to protect web applications and application programming interfaces (APIs). A WAF monitors and filters web application traffic, such as HyperText Transfer Protocol (HTTP) and HTTP Secure (HTTPS) traffic, between a web application and the Internet.

### BRIEF DESCRIPTION OF THE DRAWINGS

Embodiments of the disclosure may be better understood by referencing the accompanying drawings.

FIG. 1 is a diagram of a web application security service learning behavior of application traffic and learning fingerprints of features of the application.

FIG. 2 depicts a web application security service monitoring application traffic for an application using the learned application request traffic behavior and feature fingerprints.

FIG. 3 is an example deployment of the web application security service 201 as part of a Secure Access Service Edge (SASE) solution.

FIG. 4 is a flowchart of example operations for learning time-series request behavior for an application.

FIG. 5 is a flowchart of example operations for learning application feature fingerprints from application traffic data.

FIG. 6 is a flowchart of example operations for in-line monitoring application traffic with the learned time-varying volume-based application traffic behavior and time-invariant application fingerprint to detect suspicious or anomalous activity.

FIG. 7 is a flowchart of example operations for identifying a suspicious session in a time interval using feature fingerprints.

FIG. 8 depicts an example computer system with in-line application security.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses the term application feature to refer to a function or capability provided by a web application. In the context of a web application, a feature is definable based on a page that presents content and functionality corresponding to the function or capability. As an example, a dashboard of overall assets is a feature of a banking or financial application. While filtering the data presented via the dashboard can be considered another functionality, that functionality is within the dashboard and not considered a separate feature. An investing account dashboard that is separate from the asset dashboard can be considered another feature. Another characteristic of a feature of a web application is the “firing” of requests associated with the feature. When a page corresponding to a feature is first requested, the loading of that page often initiates or triggers additional requests for the page to render. Thus, an application feature can be considered a page-level request that initiates other requests.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

As in many cybersecurity areas, attack techniques against web applications continue to evolve. Malicious actors will scout security of web applications and determine, for example, a threshold of total requests to the web application that has been defined to detect suspicious activity. A single-dimension threshold, however, is easy to evade. A web application security service has been created that learns behavior of application traffic for a web application at it changes over time and learns behavior by request type/class. With these learned application traffic behaviors, a margin of acceptable deviation can be defined that closely first to the learned time varying behaviors and used to detect anomalous or suspicious activity in live application traffic. The web application security service can also learn time invariant request patterns for the application traffic and time invariant patterns of requests for each feature of an application (“feature fingerprint”). With the time invariant request pattern, the web application security service can determine anomalous or suspicious activity not detected with the learned volume-based behaviors. With feature fingerprints, the web application security service can identify a suspicious session with a feature request pattern that does not conform to the corresponding feature fingerprint.

### Example Illustrations

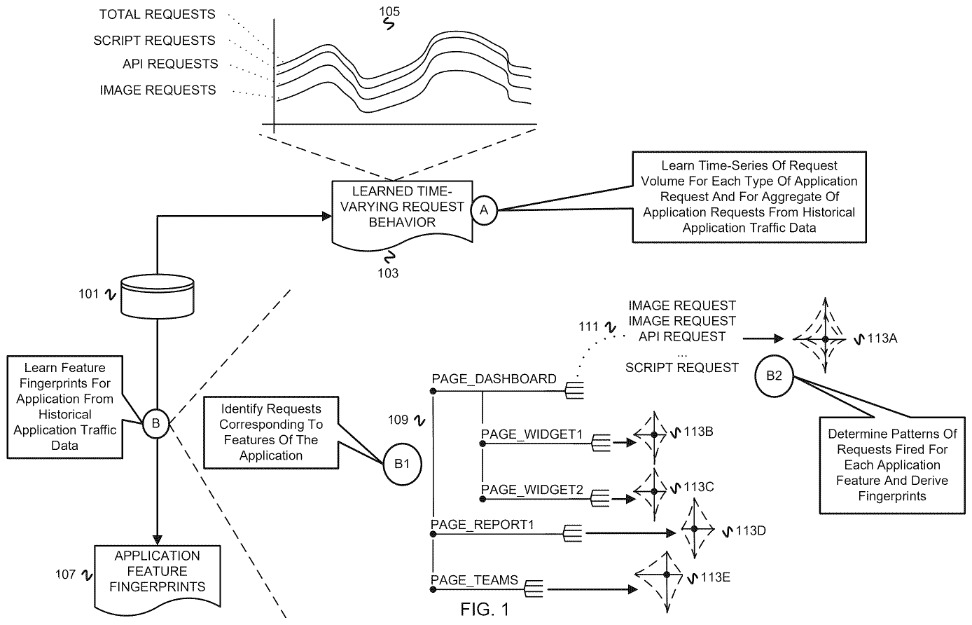

FIG. 1 is a diagram of a web application security service learning behavior of application traffic and learning fingerprints of features of the application. The web application security service will have access to time-series application traffic data for an application to be protected by the web application security service. FIG. 1 depicts a database 101 as a repository of application traffic data. While the examples illustrated herein refer to one web application, the web application security service can be deployed to protect multiple web applications. The web application security service would learn the application traffic behavior and feature fingerprints for each of the protected web applications.

FIG. 1 is annotated with a series of letters A, B, B1, and B2 representing stages of operations, each stage corresponding to one or more operations. Stages B1 and B2 are example stages of operations that constitute the operations represented by stage B. Although these stages are ordered for this example, the stages illustrate one example to aid in understanding this disclosure and should not be used to limit the claims. Subject matter falling within the scope of the claims can vary from what is illustrated.

At stage A, the web application security service analyzes time-series application traffic data in the database 101 to learn time-varying request behavior 103 of the application traffic for the application. Application traffic data will include requests and responses, such as HTTP requests and responses. The web application security service analyzes the application traffic data to learn volume of requests of each request type received for the application in regular time intervals of a time domain captured with the application traffic data. Each regular time interval is at a defined temporal granularity, such as 1 minute. The web application security service also learns the volume of requests in aggregate (i.e., across request types) for the application in each time interval.

FIG. 1 depicts a graph 105 that visually presents the time-varying application behavior learned by the web application security service. The graph 105 includes 4 curves. The curves are described from the topmost curve to the bottom curve in the graph 105. A topmost curve represents the total requests for the application detected by monitoring points, such as network elements of a software-defined wide area network (SD-WAN), across the application traffic data time domain. A curve below the topmost curve represents requests for scripts that were detected. The next curve represents application programming interface (API) requests or API calls. The next curve represents requests for images.

At stage B, the web application security service learns feature fingerprints 107 for the application from the historical application traffic data in the database 101. This is decomposed into stages B1 and B2 in FIG. 1.

At stage B1, the web application security service identifies requests corresponding to features of the application. The web application security service analyzes the traffic to identify requests that correspond to feature invocations, such as initial page requests. FIG. 1 depicts a hierarchy 109 of page requests identified by the web application security service. The hierarchy 109 includes a webpage requested for a dashboard of the application—PAGE_DASHBOARD. The hierarchy 109 depicts two features widget1 and widget2 accessible via the dashboard. The hierarchy 109 depicts these two features with corresponding pages identified as PAGE_WIDGET1 and PAGE_WIDGET2. These page loads may update the dashboard page. The hierarchy 109 also indicates a report feature and a teams feature with pages identified as PAGE_REPORT1 and PAGE_TEAMS, respectively. The report feature and the teams feature are at a same level as the dashboard feature. The dashboard page may be loaded initially. A navigation menu allows a user to navigate to either of the report and teams features which causes loading of the corresponding page. The hierarchy 109 depicts each feature associated with a tree. Each tree represents the requests that are “fired” at loading of a page corresponding to a feature. FIG. 1 depicts fired or dependent requests 111 represented by the tree of the dashboard. The fired requests 111 include two image requests, an API request, a script request, and other requests not illustrated.

At stage B2, the web application security service determines patterns of requests fired for each application feature. The web application security service then derives a feature fingerprint for each of the application features based on their request patterns. Proximate to the dependent requests 111 and the trees of the application features, FIG. 1 depicts small graphs or “spider” graphs 113A-113E (due to vaguely resembling spider webs). The spider graphs 113 represent the feature fingerprints. The web application security service determines patterns of requests occurring after each feature invocation. The request patterns for a same feature can vary due to various parameters, such as different user permissions or different user settings. For example, the web application security service determines that one dashboard invocation fired 2 image requests, 5 API calls, 2 cascading stylesheet (CSS) requests, and 3 script requests. The web application security service determines that another dashboard invocation fired 4 image requests, 7 API calls, 2 cascading stylesheet (CSS) requests, and 5 script requests. The web application security service records the different patterns and derives the feature fingerprint 113A for the dashboard feature. For instance, the derived feature fingerprint may indicate each pattern of requests: 2:5:2:3 and 4:7:2:5. The feature fingerprints 113B, 113C, 113D, and 113E respectively correspond to the application features widget1, widget2, report1, and teams. Each of the fingerprints 113B-113E is only depicted with single dashed arcs relating the different requests represented by the axes for simplicity of illustration.

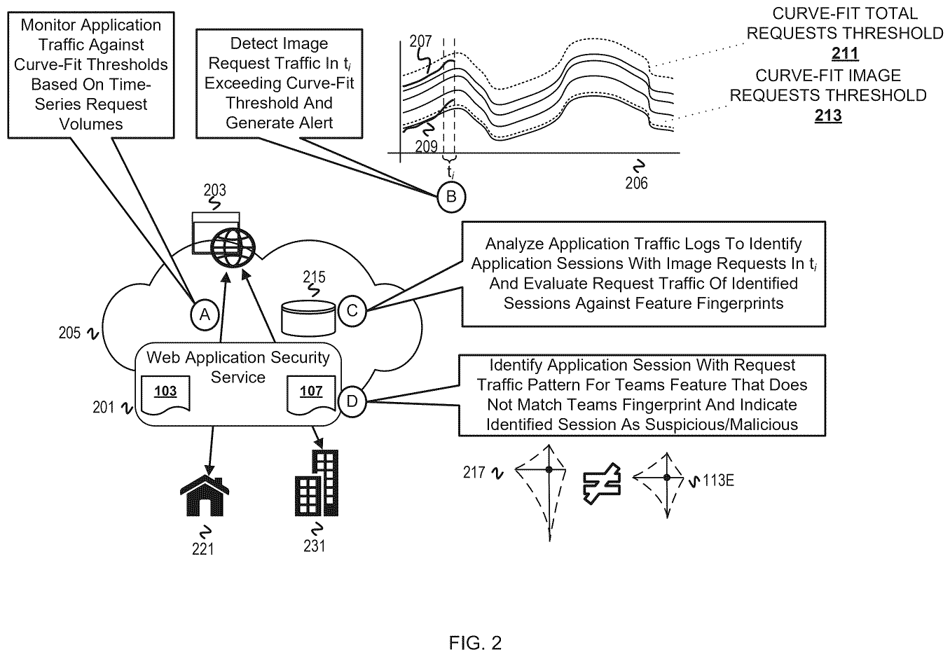

FIG. 2 depicts a web application security service monitoring application traffic for an application using the learned application request traffic behavior and feature fingerprints. In FIG. 2, a web application security service 201 monitors application traffic of an application 203 that is delivered via a cloud infrastructure 205. The web application security service 201 is monitoring traffic using the learned time-varying request behavior 103 and the feature fingerprints 107. Remote users 221 and users at one or more branch offices 231 access the application 203.

FIG. 2 is annotated with a series of letters A-D representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the web application security service 201 monitors application traffic to the application 203 against curve-fit thresholds based on time-series request volumes. The curve fit thresholds depicted in FIG. 2 represent margins of acceptable deviation defined for the application. For example, an administrator may define the margin of acceptable deviation as 5% greater than learned volume for a time interval.

FIG. 2 depicts a curve-fit threshold 211 for total requests and a curve-fit threshold 213 for image requests. A graph 206 depicts curves for the learned time-varying application request traffic behavior that were depicted in graph 105 of FIG. 1 and the curve-fit thresholds 211, 213.

At stage B, the web application security service 201 detects a volume of image request traffic in a time granule tᵢ exceeding the curve-fit threshold 213 for image requests and generates an alert. A curve 209 in the graph 206 represents observed live image request application traffic detected by the web application security service 201.

The graph 206 also depicts a curve 207 that represents the total volume of live application traffic to the application 203. The total volume does not exceed the curve-fit threshold 211. Thus, a security solution that relied upon a time-invariant threshold of total volume would not have detected the suspicious activity of image requests in the time granule tᵢ.

At stage C, the web application security service 201 analyzes application traffic logs to identify application sessions with image requests in tᵢ and evaluates the request traffic of the identified sessions against feature fingerprints. Application traffic data will have been recorded into traffic logs in a repository 215. The web application security service 201 accesses those traffic logs to analyze application traffic to correlate image requests in tᵢ with active sessions with the application 203 to identify sessions for further analysis. For each identified session, the web application security service 201 correlates traffic in tᵢ with feature invocations and then extracts request patterns of those feature invocations. The web application security service 201 evaluates the extracted request patterns against the feature fingerprints 107.

At stage D, the web application security service 201 identifies an application session with a request traffic pattern 217 for the teams feature of the application 203. The web application security service 201 evaluates the traffic pattern 217 against the feature fingerprint 113E of the teams features and determines that they do not match. Based on the lack of a match, the web application security service 201 indicates the identified session as suspicious or malicious depending on configuration of the web application security service 201. An administrator may configure the web application security service 201 to generate a malicious notification and trigger security measures or security actions on the identified session. The administrator may configure the web application security service 201 to generate an alert that the session is suspicious and cause a security analyst to investigate.

While FIG. 2 depicts the web application security service 201 as a singular service residing between users and an application being protected, deployments are likely more complex. An application security service can be deployed as part of a Secure Access Service Edge (SASE) solution that leverages SD-WAN network elements. In addition, a web application security service can be part of a cybersecurity platform and interact with other features/services of the platform. For example, the web application security service can leverage SD-WAN technology to obtain or access application traffic detected from in-line monitoring of application traffic to a protected application and communicate alerts or information to other services of the platform.

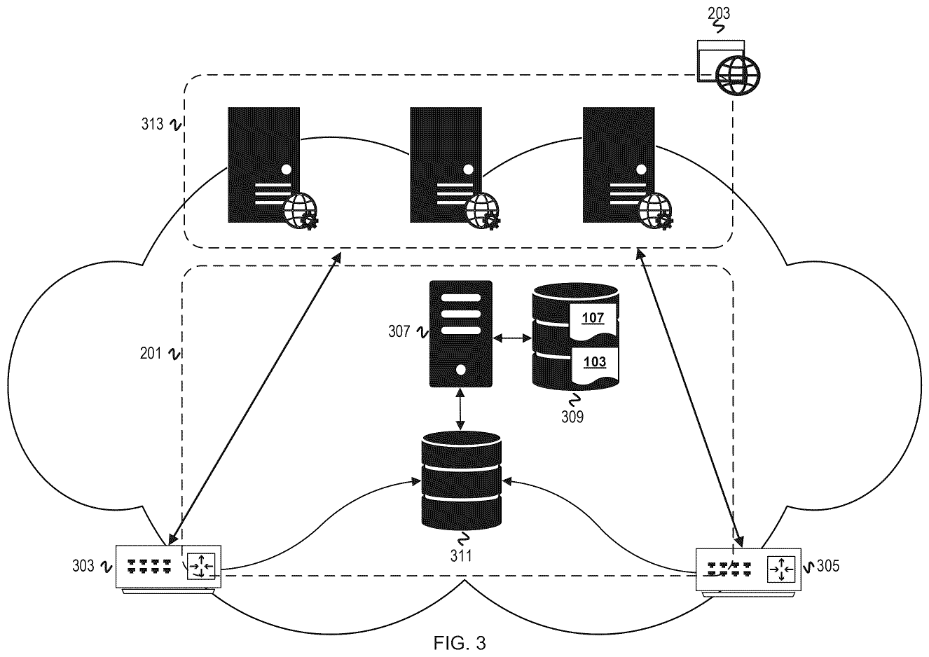

FIG. 3 is an example deployment of the web application security service 201 as part of a SASE solution. The web application security service 201 is depicted with a dashed line that encompasses multiple components: a repository 311, a repository 309, network element 303, and network element 305. The network elements 303, 305 are inline with respect to the application 203 and users of the application 203. The network elements 303, 305 monitors application traffic at least by recording traffic logs to the repository 311 (e.g., a data lake or data warehouse). The network elements 303, 305 may have additional functionality, such as prefetching for application acceleration and inspecting lower layer traffic. In FIG. 2, the application 203 is delivered with a group 313 of application servers. The network elements 303, 305 likely interact with load balancers that front the group 313. Analysis functionality of the web application security service 201 is implemented at least on a server 307. The server 307 accesses the application traffic data maintained in the repository 311. With the network elements 303, 305 updating the repository 311 with application traffic data, the web application security service 201 has visibility across multiple points of access to the application 203, regardless of how the application 203 is being delivered. The server 307 can analyze this data using the time-varying request behavior 103 and the feature fingerprints 107 that have been stored into the repository 309, which may be memory of the server 307 or other network accessible storage/memory.

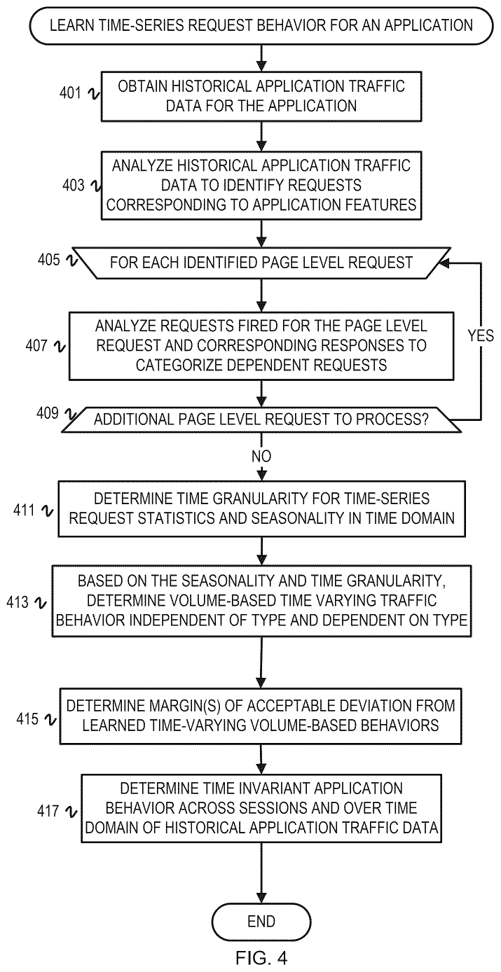

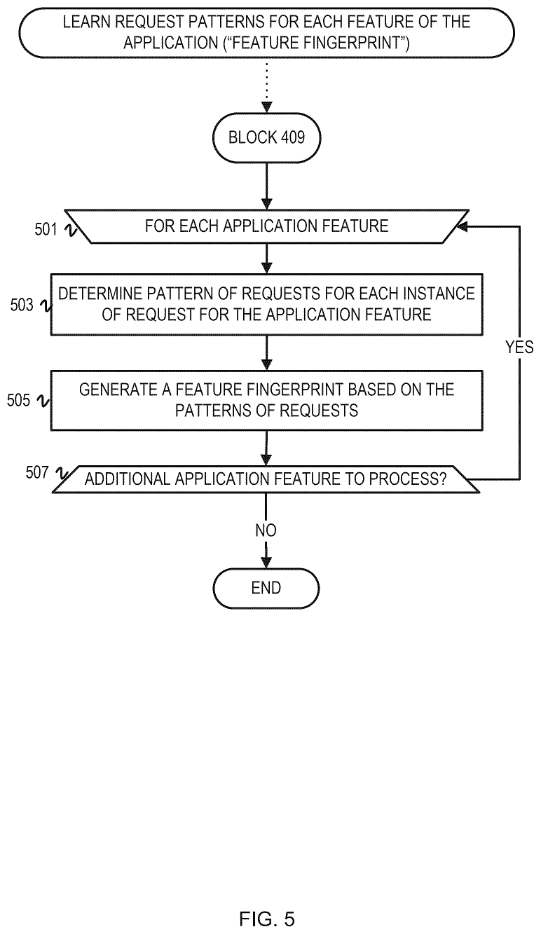

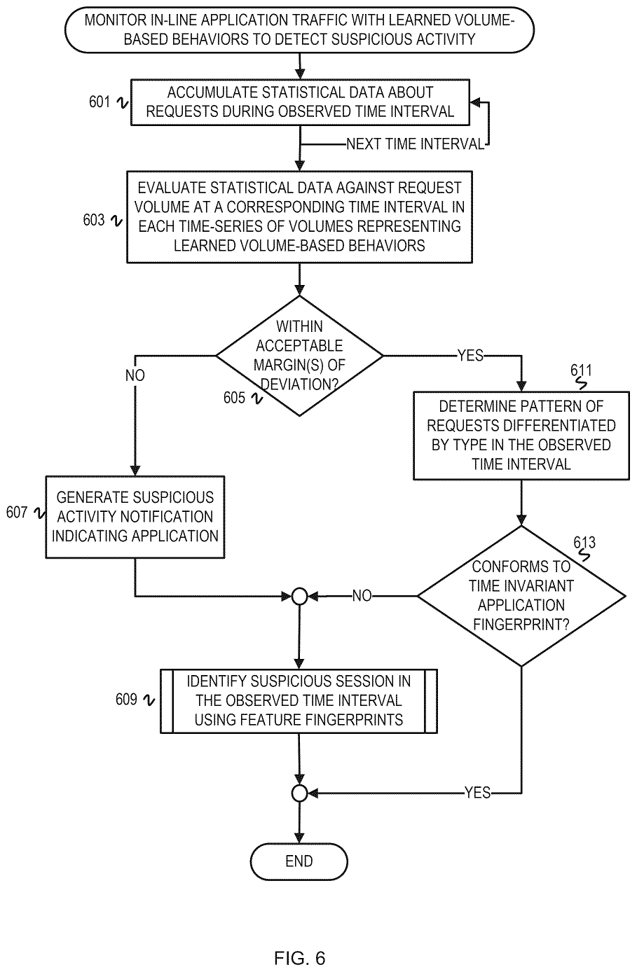

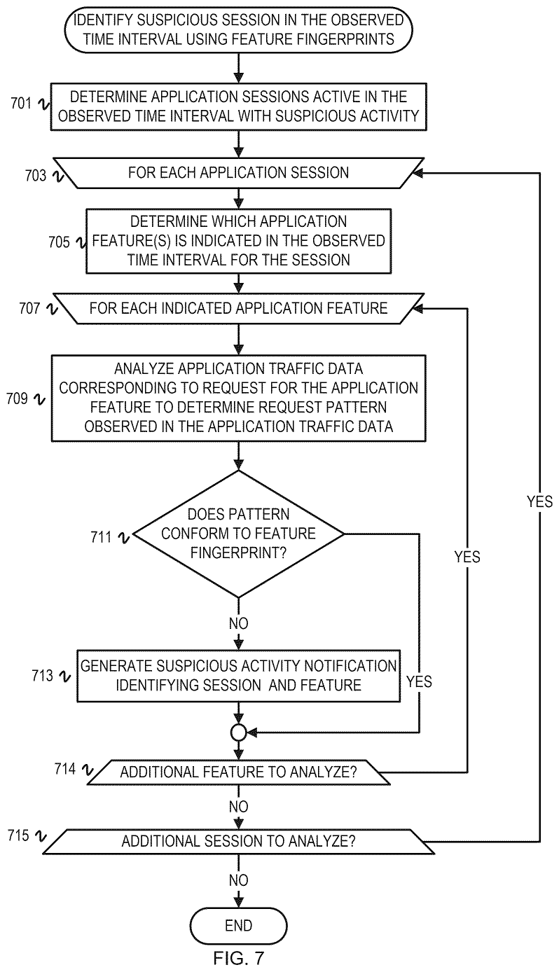

FIGS. 4-7 are flowcharts of example operations for web application security. FIGS. 4-5 relate to learning application request behavior and feature fingerprints and FIGS. 6-7 relate to monitoring application traffic with the learned information to detect suspicious, anomalous, or malicious activity. The example operations are described with reference to a web application security service for consistency with the earlier figures and/or ease of understanding. The name chosen for the program code is not to be limiting on the claims. Structure and organization of program code can vary due to platform, programmer/architect preferences, programming language, etc. In addition, names of code units (programs, modules, methods, functions, etc.) can vary for the same reasons and can be arbitrary.

FIG. 4 is a flowchart of example operations for learning time-series request behavior for an application. Learning request behavior includes learning the different request types that occur in application traffic and seasonality of application traffic data. Learning the different aspects of application traffic behavior for different request types allows for stricter evaluation of application traffic and adaptive monitoring. The learning can be repeated as sufficient amounts of application traffic data are accumulated.

At block 401, the web application security service obtains historical application traffic data for the application. For instance, the web application security service reads or retrieves logs of application traffic maintained for an application.

At block 403, the web application security service analyzes the historical application traffic data to identify requests corresponding to application features. Heuristics-based rules can inform the identification of which requests in application traffic correspond to application features. For instance, heuristics-based rules may specify that document type requests (“page-level requests”) correspond to application features.

At block 405, the web application security service analyzes the application traffic of each identified page level request. Each page level request will trigger or fire one or more other requests to retrieve content and/or functionality to render a page for an application feature.

At block 407, the web application security service analyzes requests fired for the page level request and corresponding responses to categorize dependent requests by type or class. The web application security service examines the data and/or metadata of each request to categorize the request. For instance, the web application security service categorizes a request as a script request type based on detecting “jquery” in a uniform resource locator (URL) in the request header. In some cases, the web application security service examines a request and its corresponding response to categorize the request. For instance, the web application security service categorizes a request as a stylesheet request type based on detecting “styles” in a uniform resource locator (URL) in the request header and a pattern or regular expression in the corresponding response that have previously been identified as appearing in responses to requests for stylesheets (e.g., a pattern indicative of styles being loaded). Categorizing the requests allows the web application security service to differentiate requests which provides insight or intelligence into the constituent traffic. This visibility of requests at the level of request type facilitates monitoring application traffic in more detail and reduces the space for malicious actors to hide their activities by operating “below the radar” of less strict/detailed monitoring (e.g., a time invariant total volume of requests).

At block 409, the web application security service determines whether there is another page level request that was identified. If there is another page level request that was identified, operational flow returns to block 405. Otherwise, operational flow proceeds to block 411.

At block 411, the web application security service determines time granularity for time-series request statistics and seasonality of a time domain of the historical application traffic data. Presumably, the historical application traffic data will encompass sufficient data to reveal seasonality. For instance, the historical application traffic data encompasses several weeks of data to reveal the trends that recur on a daily or weekly basis. As more historical application traffic data accumulates, additional layers of seasonality can be determined to learn time-varying application traffic behavior of different cycles or seasons. For instance, different time-varying behavior can be determined for weeks in months corresponding to end of a quarter and/or months laden with holidays. The web application security service can use a statistical analysis tool (e.g., autocorrelation analysis) to determine the seasonality(ies) of the historical application traffic data. Seasonality of the data can be specified by an administrator or data scientist familiar with the application and/or based on expected seasonality (e.g., weekly). With respect to granularity for the time-series request statistics, an administrator can configure an appropriate time granularity based on awareness of systems and available resources for analysis, for example.

At block 413, the web application security service, for each granule of the determined time granularity and based on the seasonality, determines volume-based behavior of request traffic independent of request type and dependent upon request type. Based on the seasonality of the historical application traffic data, the web application security service determines, for each time granule (e.g., 1 minute) of the historical application traffic data, volume of requests by request type. In addition, the web application security service determines the aggregate volume of the requests across request types within the granule. To illustrate with weekly seasonality and 1-minute time granularity, the web application security service will determine the volumes of request per request type and across request types for each granule and generate a time-series of volumes per request type and time-series of request volume across request types for each week. For the request time independent behavior and each request type dependent behavior, the web application security service can aggregate the per week time-series into a time-series of volumes for a time domain of a week. For example, the maximum volume for image requests for each fixed time across weeks is used to generate the time-series of volume-based behavior for image requests. Alternatively, volumes could be normalized across weeks to generate the type independent and type dependent time-series of volumes.

At block 415, the web application security service determines a margin of acceptable deviation from the learned time-varying volume-based behaviors of application traffic. Different margins can be configured for the type independent and type dependent time-varying volume-based behaviors. The margins can be configured as an absolute acceptable margin of deviation (e.g., additional 100 requests) or relative acceptable margin of deviation (e.g., additional 2%).

At block 417, the web application security service also determines time-invariant application behavior over the time domain of the historical application traffic data and across application sessions. To determine the time-invariant application behavior, the web application security service analyzes the application traffic data to determine a pattern of requests differentiated by request type in each granule. The time granularity for this analysis can be the same or different than the time granularity for the time-varying behavior analysis. Similar to the feature fingerprint, the web application security service analyzes the historical application traffic data to determine relationships in volumes of requests differentiated by request type. Unlike the feature fingerprint analysis, the time-invariant application behavior analysis determines a pattern among the type differentiated requests within a granule across sessions. For example, the web application security service determines that 20 application sessions in a granule yielded 1000 script requests, 200 image requests, 40 requests to example1.com, and 100 requests to example2.com. In another granule, the web application security service determines that 80 application sessions yielded 4000 script requests, 800 image requests, 160 requests to example1.com, 400 requests to example2.com, and 40 requests to orgA.example1.com.

The web application security service can determine the time-invariant behavior of application traffic (“time-invariant application fingerprint”) with 2 patterns: [script: 5, image: 10; example1.com: 2; example2.com: 5] and [script: 10, image: 20; example1.com: 4; example2.com: 10; orgA example1.com: 1].

FIG. 5 is a flowchart of example operations for learning application feature fingerprints from application traffic data. Learning application feature fingerprints can be performed in conjunction with learning the time-varying volume-based application request behavior or separately. FIG. 5 presumes that the learning is performed in conjunction to efficiently use access of the historical application traffic data. Thus, FIG. 5 begins with operational flow from block 409 of FIG. 4 to block 501 of FIG. 5. Thus, the operations of FIG. 5 leverage the analysis of blocks 405, 407, 409 that categorize request types occurring in the application traffic data obtained at block 401. In implementations that perform the learning together, the operations of blocks 411, 413, 415 can be performed before, after, or concurrently with the example operations of FIG. 5.

At block 501, the web application security service begins examining application traffic data corresponding to each identified application feature. Prior analysis will have already identified the requests that correspond to an application feature, such as requests for documents.

At block 503, the web application security service determines a pattern of requests for each instance of request/invocation for the application feature. Since multiple instances of invocation of an application feature can occur in the application traffic data, the web application security service identifies requests fired for each application feature invocation, or as previously referred page-level request. Determination of which requests to associate or group with a page-level request can be based on a temporal boundary or a request boundary. For example, the web application security service can select requests that occur prior to a next page-level request and that occur within a defined time limit (e.g., 700 milliseconds). The time limit aids in excluding requests fired prior to another page-level request or for other purposes unrelated directly to the application (e.g., performance monitoring requests). The web application security service determines a pattern of requests from the selected requests. For instance, the web application security service determines that 39 requests were fired subsequent to the page-level request within the association boundaries, 9 of those requests were CSS requests, 12 of those requests were script requests, 8 of those requests were image requests, 6 of those requests were cookie requests, and 4 requests were API calls.

At block 505, the web application security service generates a feature fingerprint based on the patterns of requests. Each instance of the page-level request can have a different pattern for various reasons. Different content may be delivered for an application feature depending upon user role, geographic location, etc. The web application security service generates a fingerprint for the feature based on normalizing the patterns of requests determined across the instances of the page-level request. A feature fingerprint can allow for flexibility in matching or conformance that accounts for the possible variations in fired requests. For instance, a feature fingerprint can specify a range of total requests and a percentage or percentage range of that total for each type of request. In addition, a feature fingerprint can indicate different request patterns. For instance, the pattern of requests associated with an initial page-level request in a session can be significantly different than a pattern of requests for subsequent instances of the page-level request in a same session due to caching, as an example. The feature fingerprint can index one pattern based on a range of total requests. The feature fingerprint can index a first request pattern with a range of 40-50 fired requests and index a second pattern with a range of 15-20 fired requests. Implementations can index patterns by an individual type of request instead of total requests for a feature. For instance, a pattern could be designated for m script requests and a different pattern for n script requests, where n!=m.

At block 507, the web application security service determines whether there is application traffic data for another application feature to process. If there is application traffic data for another application feature, then operational flow returns to block 501. Otherwise, operational flow ends for FIG. 5 or proceeds to block 411 of FIG. 4 depending upon implementation. Learning feature fingerprints is repeated periodically or on demand. Subsequent learning captures changes that can result from application updates, for example. Thus, the web application security service can automatically adapt feature fingerprints to changes in applications.

FIG. 6 is a flowchart of example operations for in-line monitoring of application traffic with the learned time-varying volume-based application traffic behavior and time-invariant application fingerprint to detect suspicious or anomalous activity. The margin(s) of acceptable deviation can be defined in a security policy if margin limited behavior is being enforced. The learned time-varying behavior and/or time-invariant application fingerprint can also be used to preview of what can be detected if enforced.

At block 601, the web application security service accumulates statistical data about requests during a time interval. The web application security service maintains statistics on volumes of each request type and volume of requests independent of request type. The web application security service maintains the statistics for each monitoring time interval. FIG. 6 corresponds to implementations that evaluate the accumulated statistics after a time interval has elapsed. However, implementations may continuously evaluate the accumulated statistics against the thresholds of the current time interval to immediately detect if a threshold has been exceeded. The accumulation of statistical data of block 601 is ongoing and operational flow proceeds to block 603 when a time interval elapses.

At block 603, the web application security service evaluates the accumulated statistical data against each learned time-varying volume-based behavior. The web application security service compares the volume of requests of each request type detected in the observed time interval against the time-varying volume-based behavior and margin for that request type for the time of day of that time interval. Similarly, the web application security service compares the volume of requests independent of request type detected in the observed time interval against the type independent time-varying volume-based behavior for the time of day of that time interval.

At block 605, the web application security service determines whether observed behavior (based on the collected statistics) is within the acceptable margin(s) of deviation from the learned time-varying volume-based behaviors. If at least one behavior deviated beyond the corresponding acceptable margin, then operational flow proceeds to block 607. Otherwise, operational flow proceeds to block 611.

At block 607, the web application security service generates a suspicious activity notification indicating application. Since the web application security service may be monitoring traffic of multiple applications, the web application security service identifies in the notification the application with non-conforming behavior. In addition, the notification can indicate the request type has the anomalous behavior or that the anomalous behavior of type independent. A security analyst can investigate based on this information. In addition, other cybersecurity components can perform a security action (e.g., blocking traffic, increasing inspection of application traffic, etc.) based on the notification.

At block 609, the web application security service identifies a suspicious session in the time interval using feature fingerprints. After the detection of anomalous or suspicious request volume, further analysis can be performed with the feature fingerprints to identify one or more suspicious sessions. The operations of block 609 are described in greater detail with reference to FIG. 7.

If no suspicious or anomalous behavior was detected with respect to the time-varying volume-based behaviors at block 605, then the web application security service determines a pattern of requests differentiated by type in the observed time interval at block 611. The web application security service analyzes the statistics by request type to determine the pattern of requests across sessions. For instance, the web application security service indicate that there were 50 active applications sessions in the observed time interval and that 1200 API calls to a first domain occurred, 350 script requests occurred, and 200 API calls to a second domain occurred: [script: 350, first_domain: 1200; second_domain: 200].

At block 613, the web application security service determines whether the determined application request pattern conforms to a time-invariant application fingerprint. The web application security service can normalize the determined pattern by reducing the ratios of requests, referring to the preceding example, to [script: 7, first_domain: 24; second_domain: 5]. Assuming the time-invariant application fingerprint indicates multiple patterns, the web application security service can use one of the values to select a pattern either by matching values or finding a pattern that indicates a range for a request type that includes a value from the pattern determined from the observed time interval. If the pattern determined from the observed time interval does not conform to the time-invariant application fingerprint, then operational flow proceeds to block 609. Otherwise, operational flow ends.

FIG. 7 is a flowchart of example operations for identifying a suspicious session in a time interval using feature fingerprints. The feature fingerprints can be used with in-line monitoring instead of conditioning the feature fingerprint analysis on detection of a volume-based behavior of application traffic. This description describes the feature fingerprint analysis with the volume-based application traffic behavior monitoring to provide an implementation of the technologies being used together in a cybersecurity solution.

At block 701, the web application security service determines application sessions active in the time interval with suspicious activity. The web application security service is “session aware,” meaning that the web application security service can contextualize the requests to an application session. For instance, traffic logs can be indexed by session or flow identifier. The web application security service or another service or component (e.g., a SD-WAN component) that is accessible by the web application security service delineates flows of request traffic by session. For example, flows of request traffic can be delineated by source and destination network address pairs.

At block 703, the web application security service analyzes the flows of request traffic for each of the application sessions. This analysis can be as depicted in FIG. 7 or the web application security service can analyze multiple flows in parallel depending on implementation.

At block 705, the web application security service determines which application feature(s) is indicated in the time interval for the session. The web application security service searches the session flow for a request corresponding to invocation of an application feature in the time interval corresponding to the suspicious activity. In addition, the web application security service can search a preceding time interval in case the initial invocation preceded the time interval.

At block 707, the web application security service examines the associated/fired request corresponding to each indicated application feature. The web application security service can select each instance of application feature invocation in temporal order.

At block 709, the web application security service analyzes application traffic data corresponding to the invocation of the application feature to determine a request pattern observed in the application traffic data. Similar to when learning feature fingerprints, the web application security service selects requests to associate with the feature based on the aforementioned association boundaries with respect to the application feature invocation determined as indicated for the time interval with suspicious request behavior activity. The web application security service ascertains a request pattern from the associated requests. The raw observations of the associated requests, such as volumes of requests per request type, can be normalized into percentages or ratios. In some implementations, the web application security service can filter out application features that are not relevant based on non-conforming request behavior. For example, the web application security service can limit analysis to those features that include a script request in its fingerprint if the non-conforming volume-based behavior relates to the script request type.

At block 711, the web application security service determines whether the ascertained pattern of requests conforms to the fingerprint of the application feature. The web application security service compares the ascertained pattern to the feature fingerprint. The feature fingerprint may indicate multiple patterns as indicated previously. In that case, the web application security service selects one of the patterns in the fingerprint based on an attribute of the ascertained pattern, such as total requests or percentage of the total requests that are stylesheet requests. If the ascertained pattern does not match the feature fingerprint, then operational flow proceeds to block 713. Otherwise, operational flow proceeds to block 715.

At block 713, the web application security service generates a suspicious activity notification that identifies the session and application feature with an ascertained pattern that did not conform to its fingerprint. The notification can be to a security analyst to cause additional investigation. The notification can trigger a security action, such as blocking traffic of the session or quarantining a session.

At block 715, the web application security service determines whether there is another session with request traffic to analyze. If so, operational flow returns to block 703. Otherwise, operational flow ends.

### Variations

The example illustrations present a system that learns time-varying volume-based behavior, both request type dependent and request type independent, that learns time-invariant application fingerprints, and that learns application feature fingerprints.

The example illustrations also describe monitoring application traffic with respect to acceptable margins of deviations with respect to the learned time-varying volume-based behaviors, time-invariant application fingerprint, and feature fingerprints. It is not necessary for these technologies to be used together. Each can be used independently of the other.

In addition, feature fingerprinting can be used in conjunction with predictive modeling informed application acceleration. This application acceleration prefetches dynamic content of an application based on predictive modeling of user behavior. For predictive modeling, the system learns the functional flows of an application and how a user interacts with the application. Learning the functional flows involves learning the requests fired for application features while learning how a user interacts with the application involves learning a common sequence of feature invocations by user. Feature fingerprinting can be integrated with this application acceleration. When a series of requests are fired for prefetching dynamic content, the system can apply the feature fingerprint to determine whether the pattern of requests for prefetching conform to the feature fingerprint.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, embodiments may not perform operations corresponding to blocks 611 and 613 if time-invariant application fingerprints are not being used. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

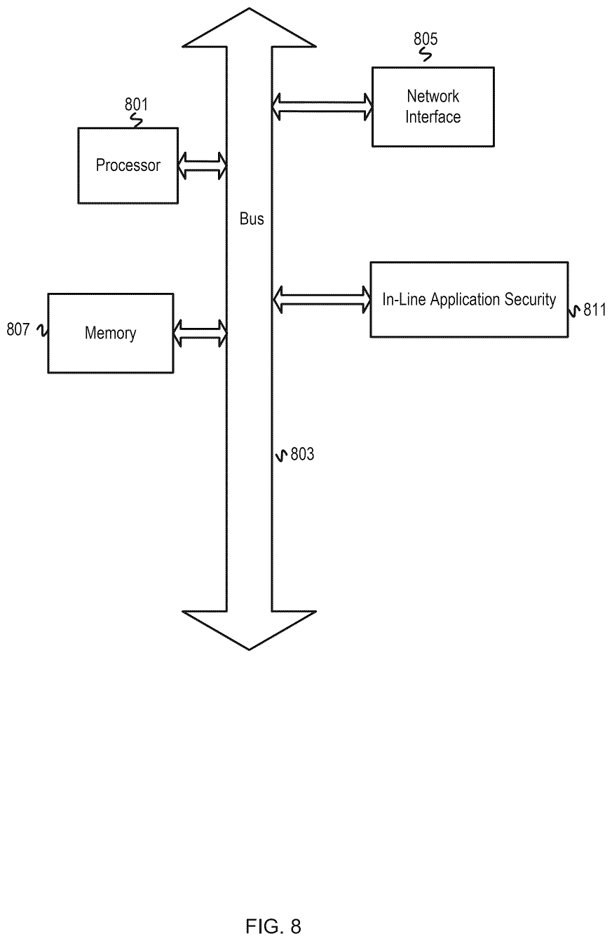

FIG. 8 depicts an example computer system with in-line application security. The computer system includes a processor 801 (possibly including multiple processors, multiple cores, multiple nodes, and/or implementing multi-threading, etc.).

The computer system includes memory 807. The memory 807 may be system memory or any one or more of the above already described possible realizations of machine-readable media. The computer system also includes a bus 803 and a network interface 805. The system also includes in-line application security 811. The in-line application security 811 can include or leverage technologies that collect data about application traffic, including metadata of requests to an application. For instance, application traffic data can be extracted from HTTP archive files, metadata of session flows maintained by SD-WAN components, etc. The in-line application security 811 learns time-varying volume-based behaviors for request type independent and request type dependent traffic, time-invariant application fingerprints, and/or application feature fingerprints. The in-line application security 811 can then monitor application traffic based on defined margins of acceptable deviations from the learned behaviors, the time-invariant application fingerprint, and/or the feature fingerprints to detect activity that is suspicious, anomalous, or malicious. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

1. A method comprising:
learning, from historical application traffic data for an application, a pattern of requests for each of a plurality of application features of the application;
for each of the plurality of application features, generating a feature fingerprint based on the pattern of requests learned for the application feature;
for a first session in monitored application traffic for the application, determining whether a pattern of requests observed in the monitored application traffic for at least a first of the plurality of application features deviates from the feature fingerprint; and
indicating the first session as malicious or suspicious based on a determination that the observed pattern of requests for the first application feature deviated from the feature fingerprint for the first application feature.

2. The method of claim 1, wherein learning a pattern of requests for each application feature comprises measuring, for each request type, requests generated in response to each invocation of the application feature and wherein generating the feature fingerprint based on the learned pattern of requests for the application feature comprises generating the feature fingerprint based on the measurements of the requests.

3. The method of claim 2, wherein generating the feature fingerprint for an application feature comprises normalizing the measurements across feature invocations.

4. The method of claim 1, wherein learning a pattern of requests for each application feature of the application comprises identifying invocations of the application feature in the historical application traffic data and, for each invocation of the application feature, identifying requests coincident with the application feature invocation.

5. The method of claim 4, wherein identifying requests coincident with the application feature invocation comprises identifying requests generated subsequent to the application feature invocation within a feature boundary, wherein the feature boundary is based on at least one of time and another application feature invocation.

6. The method of claim 1, wherein learning a pattern of requests for each application feature of the application comprises examining responses to requests to determine types of the requests.

7. The method of claim 6, wherein the types of requests comprise image, script, interface object, and application programming interface call.

8. The method of claim 1 further comprising:
detecting suspicious or anomalous activity in a first of a series of time intervals based on volume of requests of the application observed in the first time interval and a first request volume threshold in a time-series of request volume thresholds defined for the application, wherein the first request volume threshold corresponds to the first time interval; and
based on the detection of anomalous suspicious activity, analyzing individual sessions in the first time interval with the feature fingerprints, wherein the individual sessions include the first session.

9. The method of claim 8, wherein analyzing individual sessions in the first time interval with the feature fingerprints comprises, for each session, identifying each application feature invoked in the session and comparing an observed pattern of requests for the invoked application feature against the feature fingerprint of the invoked application feature.

10. A non-transitory machine-readable medium having stored thereon program code comprising instructions to:
for each of a plurality of features of an application, determine a pattern of requests across request types based on historical application traffic data and generate a feature fingerprint based on the pattern of requests;
for each session in application traffic for the application, determine whether a pattern of requests observed in the application traffic for at least a first of the plurality of application features deviates from the feature fingerprint of the first application feature; and
indicate the first session as malicious or suspicious based on a determination that the observed pattern of requests for the first application feature deviated from the feature fingerprint for the first application feature.

11. The non-transitory machine-readable medium of claim 10, wherein the instructions to determine a pattern of requests for each application feature comprise instructions to measure, for each request type, requests generated in response to each invocation of the application feature and wherein the instructions to generate the feature fingerprint based on the determined pattern of requests for the application feature comprise instructions to generate the feature fingerprint based on the measurements of the requests per request type.

12. The non-transitory machine-readable medium of claim 11, wherein the instructions to generate the feature fingerprint for an application feature comprise instructions to normalize the measurements across feature invocations.

13. The non-transitory machine-readable medium of claim 10, wherein the instructions to determine a pattern of requests for each application feature of the application comprise instructions to identify invocations of the application feature in the historical application traffic data and, for each invocation of the application feature, identify requests coincident with the application feature invocation.

14. The non-transitory machine-readable medium of claim 13, wherein the instructions to identifying requests coincident with the application feature invocation comprise instructions to identify requests generated subsequent to the application feature invocation within a feature boundary, wherein the feature boundary is based on at least one of time and another application feature invocation.

15. The non-transitory machine-readable medium of claim 10, wherein the instructions to determine a pattern of requests for each application feature of the application comprise instructions to examine responses to requests to determine types of the requests.

16. The non-transitory machine-readable medium of claim 10, wherein the program code further comprises instruction to:
detect suspicious or anomalous activity in a first of a series of time intervals based on volume of requests of the application observed in the first time interval and a first request volume threshold in a time-series of request volume thresholds defined for the application, wherein the first request volume threshold corresponds to the first time interval; and
based on the detection of anomalous suspicious activity, analyze individual sessions in the first time interval with the feature fingerprints, wherein the individual sessions include the first session.

17. The non-transitory machine-readable medium of claim 16, wherein the instructions to analyze individual sessions in the first time interval with the feature fingerprints comprises instructions to, for each session, identify each application feature invoked in the session and compare an observed pattern of requests for the invoked application feature against the feature fingerprint of the invoked application feature.

18. An apparatus comprising:
a processor; and
a machine-readable medium having stored thereon instructions executable by the processor to cause the apparatus to,
for each of a plurality of features of an application, determine a pattern of requests across request types based on historical application traffic data and generate a feature fingerprint based on the pattern of requests;
for each session in application traffic for the application, determine for regular time intervals of the application traffic whether a pattern of requests corresponding to an observed time interval in the application traffic for at least a first of the plurality of application features deviates from the feature fingerprint of the first application feature; and
indicate the first session as malicious or suspicious based on a determination that the observed pattern of requests for the first application feature deviated from the feature fingerprint for the first application feature.

19. The apparatus of claim 18, wherein machine-readable medium further has stored thereon instructions executable by the processor to cause the apparatus to:
detect suspicious or anomalous activity in a first of a series of time intervals based on volume of requests of the application observed in the first time interval and a first request volume threshold in a time-series of request volume thresholds defined for the application, wherein the first request volume threshold corresponds to the first time interval; and
based on the detection of anomalous suspicious activity, analyze individual application sessions in the first time interval with the feature fingerprints, wherein the individual sessions include the first session.

20. The apparatus of claim 19, wherein the instructions to analyze individual sessions in the first time interval with the feature fingerprints comprise instructions executable by the processor to cause the apparatus to, for each application session, identify each application feature invoked in the application session and compare an observed pattern of requests for the invoked application feature against the feature fingerprint of the invoked application feature.
